(19) United States
(12) Patent Application Publication
(10) Pub. No.: US 2026/0174281 A1
(43) Pub. Date: Jun. 25, 2026

(54) COOKING LID

(71) Applicant: ALO AIDA LLC, Newark, DE (US)

(72) Inventor: João Pedro Coelho Borges, XIAMEN (CN)

(73) Assignee: ALO AIDA LLC, Newark, DE (US)

(21) Appl. No.: 19/006,388

(22) Filed: Dec. 31, 2024

(30) Foreign Application Priority Data
Dec. 25, 2024 (CN) 202423218470.3

(51) Int. Cl. A47J 36/06; A47J 36/04

(52) U.S. Cl. CPC A47J 36/06; A47J 36/04

(57) ABSTRACT

A cooking lid includes a central part, a handle part and an annular part, the lower side of the annular part includes a horizontal annular portion facing downward and a vertical annular portion facing outward, the larger annular surface is located above the smaller annular surface, different annular surfaces correspond to cooking vessels of different sizes, the annular part has the ability to deform, the horizontal and/or vertical annular portion are/is in contact with the rim of the cooking vessel, therefore seal the rim of the cooking vessel; the handle part is located on the upper side of the central part; the central part is equipped with at least one vent hole, the vent hole is used to balance the air pressure inside and outside the cooking vessel.

### CROSS REFERENCE TO RELATED APPLICATIONS

This application is based upon and claims priority to Chinese Patent Application No. 202423218470.3, filed on Dec. 25, 2024, the entire contents of which are incorporated herein by reference.

### FIELD OF THE INVENTION

The present disclosure relates generally to the field of kitchenware, more particularly, the present disclosure relates to a universal cooking lid.

### BACKGROUND OF THE INVENTION

While using cooking vessels for steaming, boiling, stewing and other cooking methods, one should cover the opening of the cooking vessel with a suitable lid. When purchasing a cooking vessel, one often gets a lid as an accessory at the same time.

The most common lid comes with the cooking vessel is made of mostly glass or metal, one lid only suits one size of cooking vessel, if there are multiple sizes of cooking vessels at home, it would be inconvenient to find the corresponding lid each time from the lid rack.

### SUMMARY OF THE INVENTION

The problem the present disclosure aims to solve is to provide a universal cooking lid.

To achieve the above aspect, this application discloses a cooking lid, comprising a lower side configured for contacting a cooking vessel, and the cooking lid is an one-piece lid made entirely of food-grade silicone material; the cooking lid further comprises a central part, a handle part, and an annular part; the annular part surrounds the central part, and has an upside down staircase structure, a lower side of the annular part includes at least two annular surfaces that increase in size sequentially, each of the at least two annular surfaces includes a horizontal annular portion facing downward and a vertical annular portion facing outward, a larger annular surface of the at least two annular surfaces is located above a smaller annular surface of the at least two annular surfaces, the annular part is deformable by an applied force, the horizontal annular portion and/or the vertical annular portion are/is configured for contacting a rim of the cooking vessel to form a seal; the handle part is located on an upper side of the central part; the central part comprises at least one vent hole configured for balancing air pressure inside and outside the cooking vessel.

The cooking lid described above can be used to cover cooking vessels of different sizes, so it's more convenient in use. The vent hole can equalize the air pressure inside and outside the cooking vessel, so the cooking lid wouldn't be absorbed onto the cooking vessel.

In the preferred embodiment, the cooking lid includes a plurality of reinforcing ribs radiating from the handle part to an edge of the annular part, each of the reinforcing ribs is located on the upper side of the cooking lid. The reinforcing ribs enhance the rigidity of the cooking lid, so the cooking lid can be designed thinner and lighter, making it easy for users to grab.

In the preferred embodiment, when the cooking lid is in a natural state, the horizontal annular portions has a first slope inclined downwardly from an inside of the annular part to an outside of the annual part, and each of the vertical annular portions has a second slope inclined outwardly from a bottom of the annular part to a top of the annular part, ensuring a good sealing effect on cooking vessels of various sizes.

In the preferred embodiment, the handle part is hollow inside, in order to reduce the surface temperature of the handle part and prevent users from getting burned when gripping the handle part; a side wall of the handle part thickens from a bottom of the handle part to a top of the handle part, a grip area of the handle part gradually increases from the bottom of the handle part to the top of the handle part to make the handle part easy to hold by hand.

### BRIEF DESCRIPTION OF THE DRAWINGS

FIG. 1 is a top perspective view of the preferred embodiment 1 of the present invention;

FIG. 2 is a bottom perspective view of the preferred embodiment 1 of the present invention;

FIG. 3 is a cross sectional view of the preferred embodiment 1 of the present invention;

FIG. 4 is an illustration of the preferred embodiment 1 in use with a cooking vessel;

FIG. 5 is an illustration of the preferred embodiment 1 in use with a different cooking vessel;

FIG. 6 is an illustration of the preferred embodiment 1 in use with a different kind of cooking vessel;

FIG. 7 is a bottom perspective view of embodiment 2 of the present invention.

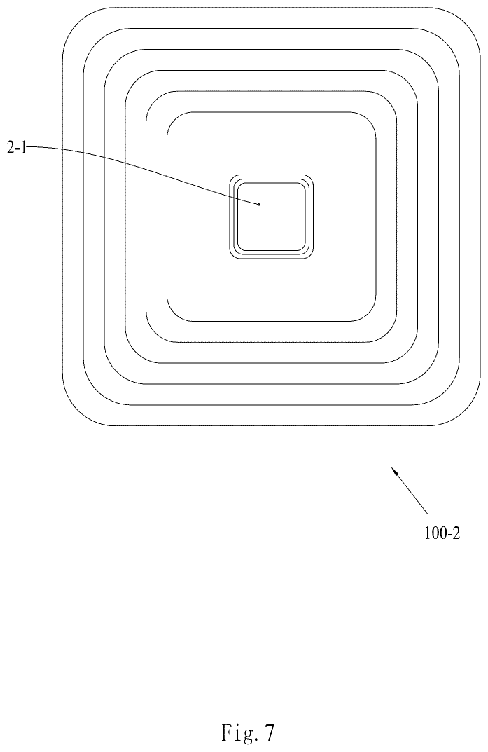

### DETAILED DESCRIPTION OF THE EMBODIMENT(S) OF THE INVENTION

Technical solutions and advantageous effects of the present disclosure will be described in detail below with reference to the accompanying drawings.

### Embodiment 1

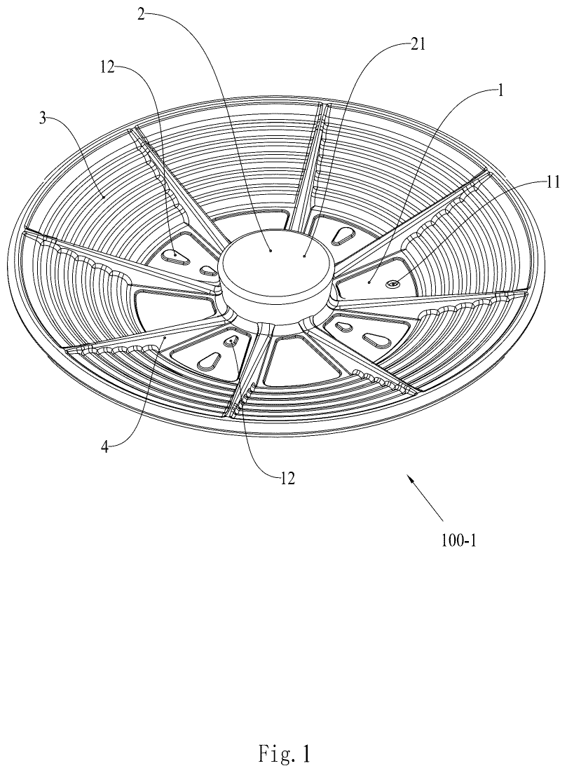

As shown in FIG. 1, the cooking lid 100-1 is a one-piece lid made entirely of food grade silicone, suitable for a temperature range of- 50° C. to 230° C., can be used as a pot lid while steaming, boiling or stewing food, and is usable in environments such as oven and microwave, if cleaning is required, it can be placed in dishwasher. The cooking 100-1 lid comprises a central part 1, a handle part 2, and an annular part 3, the central part 1 has a plate-like structure, the annular part 3 surrounds the central part 1, and has an upside down staircase structure, the annular part 3 and the central part 1 together form a concave cavity, the concave cavity's cross-section along the vertical direction has an isosceles trapezoid structure with a shorter parallel side on the bottom of the concave cavity; the handle part 2 forms on an upper side of the central part 1, and the handle part 2 is located inside the concave cavity. If needed, technicians in this field could redesign the structure of the cooking lid, for example, a handle part can be assembled onto the central part as a separable portion, a connection part between the handle part and the central part can be achieved by using a high-temperature resistant food grade plastic connector.

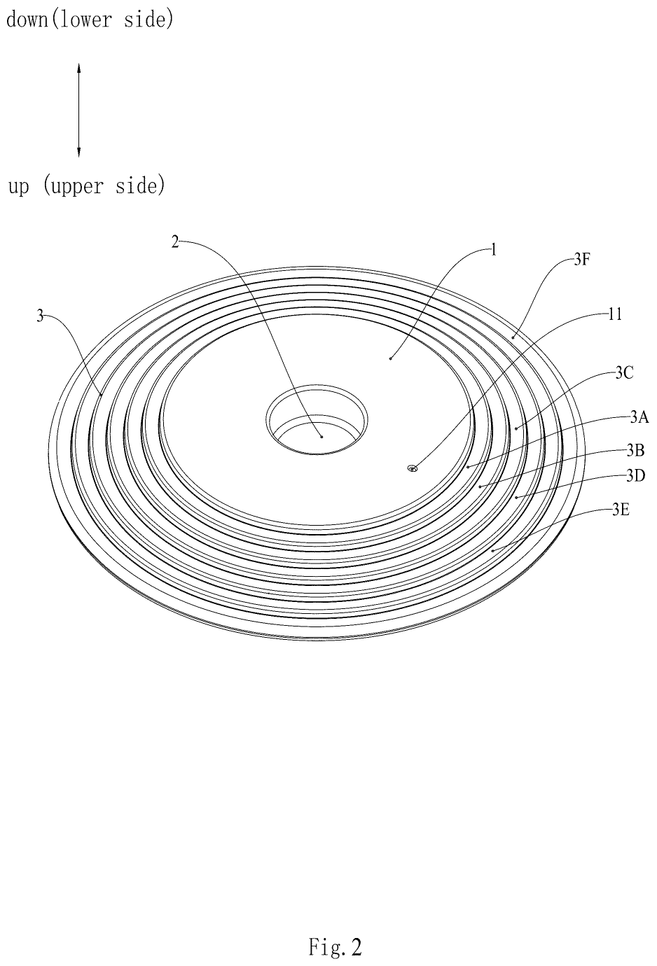

In FIG. 2, a lower side of the annular part 3 includes six annular surfaces I˜VI that increase in size sequentially from bottom to top, each annular surface includes a horizontal annular portion facing downward and a vertical annular portion facing outward. Different annular surfaces I˜VI correspond to cooking vessels of different sizes, six annular surfaces I˜VI correspond to cooking vessels with sizes of 18 cm, 20 cm, 22 cm, 24 cm, 26 cm, and 28 cm, respectively, these six sizes of cooking vessels are the most used in daily cooking, so this cooking lid is a useful one. If special requirements need to be met for other usage scenarios, technicians in this field can adjust the number and size of the annular surfaces to adapt to other combinations of cooking vessel sizes.

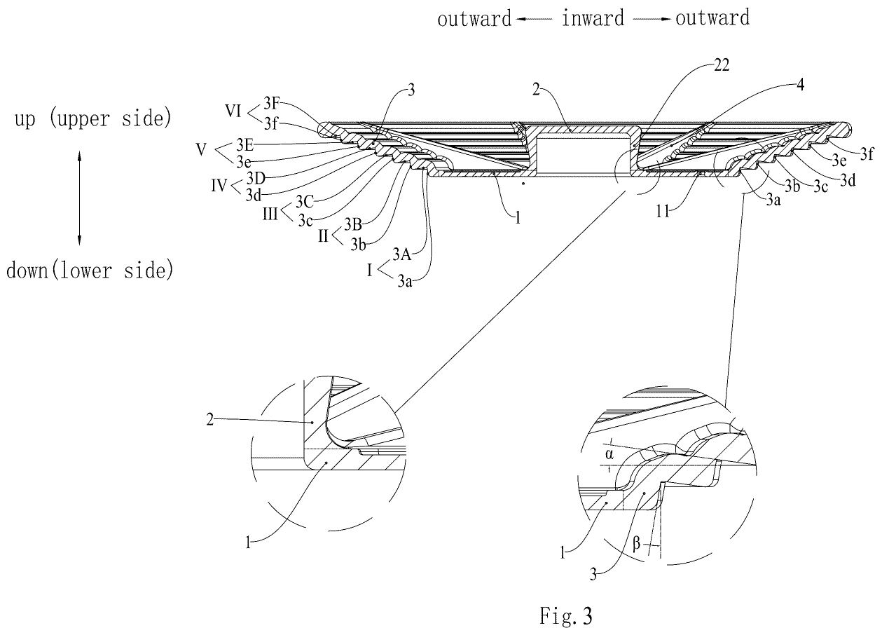

To enhance the sealing ability of the cooking lid at the rim of the cooking vessel, in FIG. 3, when the cooking lid is in a natural state, horizontal annular portions 3A˜3F not only face downward, but also tilt to face toward the central part 1, it means that each of the horizontal annular portions 3A˜3F has a first slope inclined downwardly from an inside of the annular part to an outside of the annual part; vertical annular portions 3a˜3f not only face outward, but also tilt to face toward the space beneath the annular part 3, it means that each of the vertical annular portions 3a˜3f has a second slope inclined outwardly from a bottom of the annular part to a top of the annular part, due to the annular part 3 is ability to deform, when the cooking lid is set on a cooking vessel, the annular part 3 deforms and no longer in the natural state, a tilting angle α of the horizontal annular portion 3A˜3F (an angle α between the first slope and a horizontal plane) and the tilting angle β of the vertical annular portion 3a˜3f (an angle β between the second slope and a vertical plane) can both change to fit the rim of the cooking vessel better. Preferably, when the cooking lid is in the natural state, the tilting angle α of the horizontal annular portion is 8°±2°, the tilting angle β of the vertical annular portion is 9°±2°.

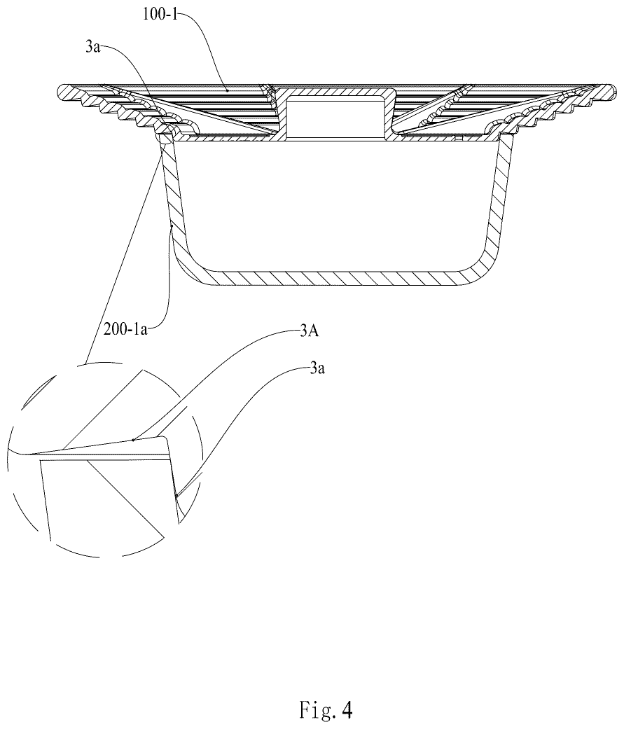

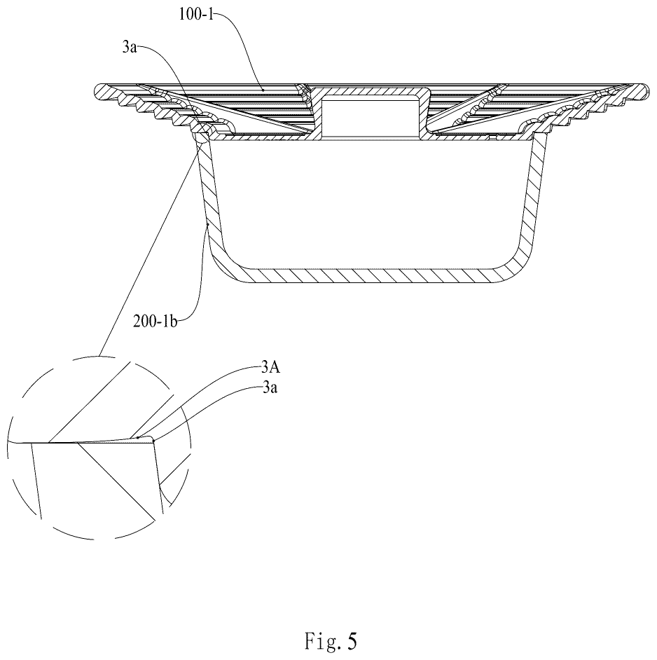

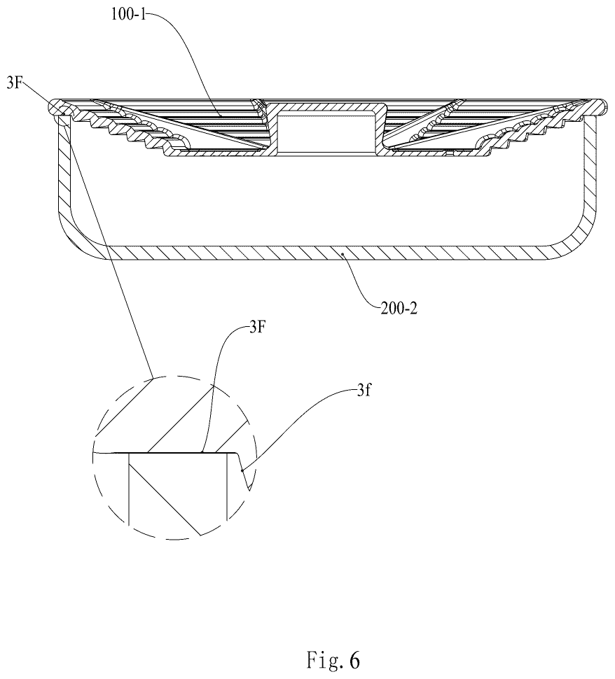

The position of contact between the rim of cooking vessels of different shapes and sizes and the cooking lid may vary. The rim of a cooking vessel may only be in line or surface contact with a horizontal annular portion 3A˜3F, or only be in line or surface contact with a vertical annular portion 3a˜3f, or be in contact with a horizontal annular portion 3A˜3F and a vertical annular portion 3a˜3f simultaneously. In FIG. 4, the cooking vessel 200-1 a is about size 18 cm, and has a non-vertical side wall, only the vertical annular portion 3a of the cooking lid 100-1 touches the cooking vessel 200-1a. In FIG. 5, the cooking vessel 200-1b is nearly the same as the cooking vessel 200-1a, the cooking vessel 200-1b is slightly bigger, both the vertical annular portion 3a and the horizontal annular portion 3A of the cooking lid 100-1 touch the cooking vessel 200-1b. In FIG. 6, the cooking vessel 200-2 is about size 28 cm, and has a vertical side wall, only the horizontal annular portion 3F touches the cooking vessel 200-2. The inclination of the vertical annular portions 3a˜3f not only helps to seal the rim of the cooking vessel in some cases, but also has other merit: during the process of setting the cooking lid on the cooking vessel, the vertical annular portions 3a˜3f have some guiding effect.

The central part 1 is equipped with a vent hole 11, which serves to balance the air pressure inside and outside the cooking vessel when the cooking lid is placed on the cooking vessel. Therefore, it is not proper to set the vent hole 11 on the annular part 3. When designing the vent hole 11, the aperture of the vent hole 11 should be within a relatively suitable range, approximately 3 to 4 millimeters, so that the vent hole 11 will not be easily blocked due to a too small aperture, nor will it have too much exhaust volume due to a too big aperture, which will affect the cooking effect. The number of vent holes 11 is generally one, but if there are special requirements, more vent holes 11 can also be allowed.

To reduce the weight of the cooking lid, the overall thickness of the cooking lid is relatively thin. A plurality reinforcing ribs 4 form on the upper side of the cooking lid to enhance its structural stability and prevent it from collapsing. In FIG. 1, the cooking lid has a total of eight reinforcing ribs 4, which extend radially from the handle part 2 to the edge of the annular part 3. The eight reinforcing ribs 4 are arranged at equal circumferential angular intervals. In other embodiment, it is also possible to prevent the cooking lid from being too soft and difficult to use by using materials with higher hardness or increasing the thickness of the cooking lid.

Eight reinforcing ribs 4 divide the upper surface of the central part 1 into eight areas, with four areas having reinforcing blocks 12. Each of these four areas has two reinforcing blocks 12, one bigger and one smaller. Four pairs of reinforcing blocks 12 are arranged at equal circumferential angular intervals, enhancing the structural stability of the central part 1. If reinforcement blocks 12 are set in all eight areas, it may result in a decrease in the bending ability of the central part 1.

In order to reduce the surface temperature of the handle part 2 and prevent users from getting burned when gripping the handle part 2 and moving the cooking lid, the handle part 2 is hollow inside. In order to facilitate the formation of the handle part 2 in the central part 1, the lower end of the handle part 2 is provided with an opening, and there is a hole on the central part 1 corresponding to the opening of the handle part 2. In order to prevent the handle part 2 from collapsing easily when held by hand, a side wall 22 of the handle portion 2 gradually thickens from the bottom of the handle part to the top of the handle part. In order to make the handle part 2 easy to hold by hand, the outer diameter of the handle part 2 gradually increases from the bottom of the handle part to the top of the handle part, and a grip area of the handle part 2 gradually increases from the bottom of the handle part to the top of the handle part.

### Embodiment 2

In FIG. 6, the difference between this embodiment and embodiment 1 is shown: the cooking lid 100-1 in embodiment 1 has a round shape, suitable for cooking vessels with circular openings; the cooking lid 100-2 provided in this embodiment has a square shape, suitable for cooking vessels with square openings. Meanwhile, the handle part 2 of cooking lid 100-1 has a circular cross-section along the horizontal direction; The handle part 2-1 of cooking lid 100-2 has a square cross-section along the horizontal direction. If needed, the handle part 2-1 can also be designed to have a different shape, such as a round shape like the handle part 2 of cooking lid 100-1.

The main concept of the present disclosure is to use food-grade and high-temperature resistant silicone to make a lid with an annular part that has an upside down staircase structure, so that the lower side of the annular part includes different sizes of annular surfaces to fit cooking vessels of different sizes. As for the shape of the annular part, it can be adaptively designed according to the shape of the cooking vessel.

The above description merely relates to embodiments of the present disclosure, and is not intended to limit the design of the present disclosure. Any equivalent changes made according to key points of the design of the present disclosure will fall within the scope of protection of the present disclosure.

What is claimed is:

1. A cooking lid, comprising a lower side configured for contacting a cooking vessel, wherein the cooking lid is an one-piece lid made entirely of food-grade silicone material; the cooking lid further comprises a central part, a handle part, and an annular part; the annular part surrounds the central part, and has an upside down staircase structure, a lower side of the annular part comprises at least two annular surfaces that increase in size sequentially, each of the at least two annular surfaces comprises a horizontal annular portion facing downward and a vertical annular portion facing outward, a larger annular surface of the at least two annular surfaces is located above a smaller annular surface of the at least two annular surfaces, the annular part is deformable by an applied force, the horizontal annular portion and/or the vertical annular portion are/is configured for contacting a rim of the cooking vessel to form a seal; the handle part is located on an upper side of the central part; the central part comprises at least one vent hole configured for balancing air pressure inside and outside the cooking vessel.

2. The cooking lid of claim 1, wherein the cooking lid further comprises a plurality of reinforcing ribs radiating from the handle part to an edge of the annular part, each of the reinforcing ribs is located on the upper side of the cooking lid.

3. The cooking lid of claim 1, wherein each of the horizontal annular portions has a first slope inclined downwardly from an inside of the annular part to an outside of the annual part, and each of the vertical annular portions has a second slope inclined outwardly from a bottom of the annular part to a top of the annular part when the cooking lid is in a natural state.

4. The cooking lid of claim 3, wherein an angle between the first slope and a horizontal plane is 8°±2°, and an angle between the second slope and a vertical plane is 9°±2° when the cooking lid is in the natural state.

5. The cooking lid of claim 1, wherein the handle part is hollow, a side wall of the handle part increases in thickness from a bottom of the handle part to a top of the handle part, a grip area of the handle part gradually increases from the bottom of the handle part to the top of the handle part.

6. The cooking lid of claim 1, wherein the central part has a plate-like structure, the annular part and the central part together form a concave cavity, a cross-section of the concave cavity along a vertical direction has an isosceles trapezoid structure with a shorter parallel side on a bottom of the central part; the handle part is located inside the concave cavity.

7. The cooking lid of claim 6, wherein an upper side of the central part is equipped with a plurality of reinforcing blocks.

8. The cooking lid of claim 1, wherein an upper side of the central part is equipped with multiple reinforcing blocks.

9. The cooking lid of claim 1, wherein the cooking lid has a circular shape, the lower side of the annular part comprises six annular surfaces, corresponding to cooking vessels of sizes 18 cm, 20 cm, 22 cm, 24 cm, 26 cm and 28 cm, respectively.

10. The cooking lid of claim 1, wherein the cooking lid has a rectangular shape.

11. The cooking lid of claim 1, wherein the cooking lid has an oval shape.
